(19) United States
(12) Patent Application Publication
(10) Pub. No.: US 2008/0223513 A1
(43) Pub. Date: Sep. 18, 2008

(54) Method and Device for Connecting Two Flexible Material Layers

(76) Inventor: Hans-Joachim Wichmann, Sendenhorst (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/066,181

(22) PCT Filed: Sep. 13, 2005
(86) PCT No.: PCT/DE2005/001617

§ 371 Date: Mar. 7, 2008

(51) Int. Cl. B32B 38/04

(52) U.S. Cl. 156/252; 156/516

(57) ABSTRACT

The manufacture of a product comprising at least two flexible material layers (14, 15) which are connected to each other by means of an adhesive coating applied to mutually facing inner surfaces of the material layers (14, 15), wherein the material layers (14, 15) are pressed together and are then intermittently perforated, is successfully achieved in a simple manner by virtue of the fact that, simultaneously with the perforation, adhesive (16) is injected from at least one outer side of the material layers (14, 15) into the formed perforation holes, whereupon the adhesive (16) is conducted into the interspace between the material layers (14, 15).

The invention relates to a process for manufacturing a product comprising at least two flexible material layers which are connected to each other by means of an adhesive coating applied to mutually facing inner surfaces of the material layers, wherein the material layers are pressed together and are then intermittently perforated.

The invention further relates to a device for connecting two flexible material layers by means of an adhesive coating applied to mutually facing inner surfaces of the material layers.

The connection of two flexible material layers is frequently required in order to close packagings, especially sack packagings, once the filling through a feed opening is concluded. The feed opening can here extend over the whole of the sack cross section (upwardly open sack), can constitute an opening formed in a sack edge or a valve in a sack bottom. The materials to be connected can here be paper layers one below the other, cardboard layers, paper and foils, foils one below the other, fabric layers and synthetic fabric layers with one of the other materials.

Numerous processes are known for producing a seal-tight closure of mutually adjacent material layers. For valve sacks, it is known to apply to the inner layer of the valve an adhesive coating which in the cold state is non-adhesive and to use heat to activate the bonding. A problem with this is that the adhesive coating can be inadvertently activated by elevated ambient temperatures and that the product to be filled is transported over the adhesive coating and can contaminate this, with the result that fault-free sticking is no longer possible.

The closure of outer valves, inner valves and end valves has also been conducted with an ultrasonic welding. This process demands, however, an appropriate configuration of the inner valve layer with a weldable material.

Particularly in the case of valve sacks, but also in other applications, the problem exists that an application of adhesive, for example after a sack has been filled, is problematical when the bonding must be achieved on the inner walls of the material layers. Complex devices have therefore been devised to allow adhesive to be applied to such inner walls. In this context, a well-working solution which can be realized at a reasonable cost has not been disclosed.

The object of the invention is therefore to allow two flexible material layers to be connected in a new, simple manner.

For the achievement of this object, according to the invention a process of the type mentioned in the introduction is characterized in that, simultaneously with the perforation, adhesive is squeezed from at least one outer side of the material layers into the formed perforation holes, whereupon the adhesive is conducted into the interspace between the material layers.

For the achievement of said object, a device of the type mentioned in the introduction is further characterized by a first shaped part and a second shaped part for pressing the material layers together, which shaped parts are movable relative to each other and in the closed state form a closed-off chamber traversed by the material layers; by a needle arrangement in one of the shaped parts for piercing the material layers; and by a nozzle arrangement for forcing adhesive into the pierced regions of the material layers for the introduction of adhesive into the interspace between the material layers.

The present invention allows the flexible material layers to be connected from the outer side of the material layers by an adhesive coating that connects the inner surfaces, in that the material layers, which are still free of adhesive, are pressed together from their outer sides and, at the same time, are intermittently pierced, whereupon adhesive is injected into the pierced regions, so that it makes its way onto the mutually facing inner surfaces of the material layers. The tool is here shaped such that a cohesive adhesive coating, particularly in the form of an adhesive seam, is produced. For this, a suitable spacing apart of the perforations must be chosen.

The introduction of the adhesive from the outer side via the perforation holes eliminates the problem of applying adhesive to the inner surfaces of the material layer. The handling drawbacks arising, for example, from the application of the adhesive layer and from a subsequent filling of a sack provided with the adhesive layer, are also eliminated. The inventive mutual connection of the material layers can be effected without difficulty after a sack has been filled, since the bonding and handling of the material layers is conducted from the outer side of the material layers.

In a preferred embodiment of the process according to the invention, the punctiform perforation is effected by means of hollow needles having a lateral outlet, the injected adhesive being conducted through the hollow needles into the interspace between the material layers. The use of laterally slotted needles is herein preferred.

It is particularly expedient if the material layers are pressed together by shaped parts which, in the region of the perforation, form a closed-off space around the material layers, which space also delimits the interspace between the material layers and is filled with the adhesive. An adhesive coating is thereby produced, which is located on the inner surfaces of the material layers but extends through the perforation openings also onto the outer side and forms there a defined adhesive coating or adhesive seam.

The pressing of the material layers is thus preferably effected by means of at least two shaped parts, which shaped parts are movable relative to each other.

The shaped parts can here be configured in the length of at least the adhesive coating to be applied and can be reciprocally movable perpendicular to the material layers. Alternatively hereto, the shaped parts can be configured on rotary tools, between which the material layers are passed. This is particularly advantageous in the manufacture and closure of flat-end sacks and side fold sacks.

The invention shall be explained in greater detail below with reference to an illustrative embodiment represented in the drawing, wherein:

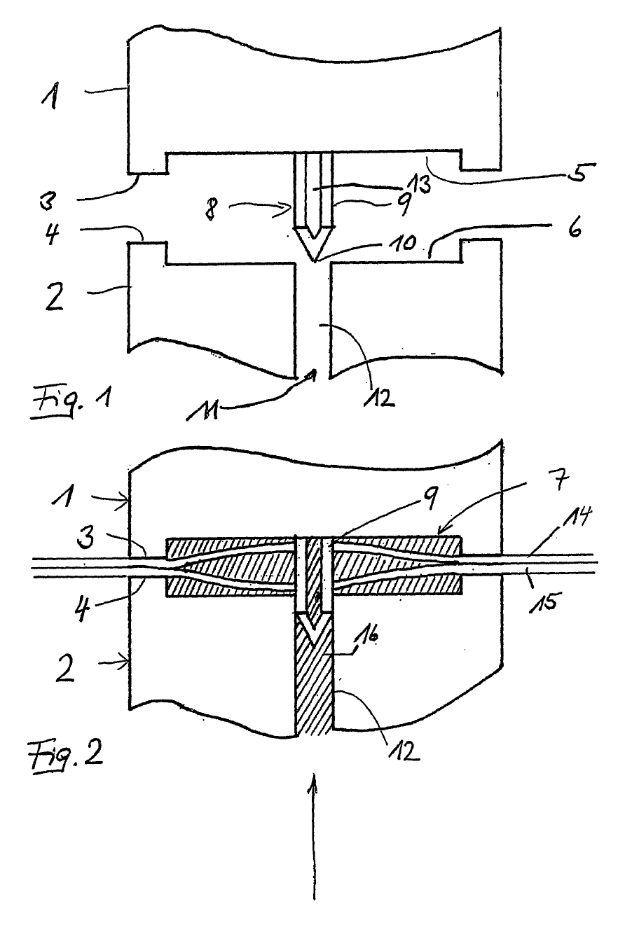

FIG. 1 shows two shaped parts, movable relative to each other, for implementing the process according to the invention, in the open state,

FIG. 2 shows the shaped parts according to FIG. 1 in the closed state, with material layers clamped between them in a sealed manner.

FIG. 1 schematically depicts a first shaped part 1 and a second shaped part 2, the two shaped parts 1, 2 being represented in an open state. In the represented drawing, the shaped parts are movable relative to each other in the vertical direction, so that they can be pressed together with pressure surfaces 3, 4. Between the pressure surfaces 3, 4, each shaped part has a recess 5, 6, which recesses, in the closed state of the shaped parts 1, 2, form a closed chamber 7, as is shown by FIG. 2.

Within the recess 5, there is centrally provided a needle arrangement 8 consisting of a large number of needles 9, the points 10 of which point in the direction of the second shaped part 2 (i.e. in the direction of the relative movement of the shaped parts 1, 2 one to the other).

Correspondingly, the second shaped part 2 has a nozzle arrangement 11 with corresponding nozzle bores 12, into which the needles 9, in the closed state of the shaped parts 1, 2, can intrude in positive-locking engagement.

The needles 9 are provided with a lateral slot 13.

For the realization of a connection of two material layers 14, 15, the shaped parts 1, 2 are opened wider relative to the partially open state in FIG. 1, to allow the material layers 14, 15 to be inserted between the shaped parts 1, 2. The shaped parts 1, 2 are then brought by converging movement into a closed state, which is represented in FIG. 2. In this state, the pressure surfaces 3, 4 of the shaped parts 1, 2 press the material layers firmly against each other outside of the closed chamber 7 formed by the shaped parts 1, 2. Within the chamber 7, the needles 9 pierce the material layers. Afterwards or at the same time, adhesive 16 is injected through the nozzle bores 12. This is conducted through the lateral, groove-like slots 13 into the region of the chamber 7 and makes its way through the material layers 14, 15, which in the region of the chamber 7 are not pressed together, into the interspace between the material layers 14, 15, so that these, in the region of the chamber 7, are forced somewhat away from each other. Due to the continuous slot 13, the chamber 7 fills with adhesive 16 both outside of and between the material layers 14, 15.

The adhesive is thus applied both between the material layers 14, 15 and outside of the material layers 14, 15.

Following the opening of the shaped parts 1, 2, the injected adhesive 16 can harden in air, but can also preferably be a hot-melt adhesive. Where a hot-melt adhesive is used, the application system for the adhesive is preferably kept at an elevated temperature, in particular by means of an induction heating.

In one variant of the device, the shaped parts 1, 2 can be disposed on rotary tools, the pressure surfaces 3, 4 of which form an invariable small gap for the realization of material layers 14, 15. If the material layers 14, 15 are realized by the rotating shaped parts 1, 2, the needles 9 perforate the material layers, whilst, at the same time, adhesive 16 can be injected through the nozzle bores 12. In this way, the connection of the material layers 14, 15 is successfully achieved also in a continuous manufacturing process.

The connection of the material layers can preferably be used to close packagings, in particular sacks, following filling. Of course, the process according to the invention can also advantageously be used for the manufacture of, for example, paper sacks, in which, from one or more flat-lying material layers, with the aid of a longitudinal seam, hose sections are formed which are open on both sides and which are then closed on one or both sides with or without the formation of a bottom.

The present invention is not confined to use with a specific type of material, but can advantageously be implemented with all conceivable material types, in particular with the material types listed in the introduction.

It can also be seen that the present invention allows more than two material layers 14, 15 to be connected in a single process step and with an unmodified device, since the adhesive 16, when injected through the nozzle bore 12 via the needle 8, is forced into all the interspaces between the different material layers 14, 15.

In one variant, it is also possible to conduct the adhesive 16 through the first shaped part 1 not through nozzle bores 12, but by supplying the slots 13 of the needle 9. In this case, the nozzle bores 12 can be dispensed with.

1. A process for manufacturing a product comprising at least two flexible material layers (14, 15) which are connected to each other by means of an adhesive coating applied to mutually facing inner surfaces of the material layers (14, 15), wherein the material layers (14, 15) are pressed together and are then intermittently perforated, characterized in that, simultaneously with the perforation, adhesive (16) is injected from at least one outer side of the material layers (14, 15) into the formed perforation holes, whereupon the adhesive (16) is conducted into the interspace between the material layers (14, 15).

2. The process as claimed in claim 1, characterized by the use of hollow needles (9) with a lateral outlet for the formation of the perforation holes and for the introduction of the adhesive (16) into the interspace between the material layers (14, 15).

3. The process as claimed in claim 2, characterized in that the distribution of the adhesive (16) is effected with slotted needles (9).

4. The process as claimed in claim 1, characterized in that, when the material layers (14, 15) are pressed together, a closed-off chamber (7) is formed around the material layers (14, 15), which is filled with the adhesive (16).

5. The process as claimed in claim 1, characterized in that the material layers (14, 15) are pressed together by means of a first shaped part (1) and a second shaped part (2), which shaped parts are movable relative to each other.

6. The process as claimed in claim 5, characterized in that the shaped parts (1, 2) are configured in the length of the adhesive coating to be applied and are reciprocally movable perpendicular to the material layers (14, 15).

7. The process as claimed in claim 5, characterized in that the shaped parts (1, 2) are configured on rotary tools, between which the material layers (14, 15) are passed.

8. The process as claimed in claim 1 for manufacturing a sack by closing a feed opening of the sack through the connection of material layers (14, 15) lying opposite each other in the region of the feed opening.

9. The process as claimed in claim 8 for manufacturing a sack, involving the closure of a feed opening formed by a feed valve.

10. The process as claimed in claim 1, comprising the formation of a linear adhesive coating.

11. A device for connecting two flexible material layers (14, 15) by means of an adhesive coating applied to mutually facing inner surfaces of the material layers (14, 15), characterized by a first shaped part (1) and a second shaped part (2) for pressing the material layers together, which shaped parts are movable relative to each other and in the closed state form a closed-off chamber (7) traversed by the material layers (14, 15); by a needle arrangement (8) in one of the shaped parts (1) for piercing the material layers (14, 15); and by a nozzle arrangement (11) for forcing adhesive (16) into the pierced regions of the material layers (14, 15) for the introduction of adhesive (16) into the interspace between the material layers (14, 15).

12. The device as claimed in claim 11, characterized in that the nozzle arrangement (11) forces the adhesive (16) into cavities in the needles (9), which have a lateral outlet.

13. The device as claimed in claim 12, characterized in that the needles are laterally slotted (9).

14. The device as claimed in claim 11, characterized in that the needle arrangement (8) is disposed in the first shaped part (1) and the nozzle arrangement (11) in the second shaped part (2), and in that the needles (9) of the needle arrangement (8) intrude into the nozzle bores (12) of the nozzle arrangement (11) when the shaped parts (1, 2) press the material layers (14, 15) together.

15. The device as claimed in claim 11, characterized in that the shaped parts (1, 2) are bars, which have at least the length of the adhesive coating to be manufactured and are reciprocally movable perpendicular to the material layers (14, 15).

16. The device as claimed in claim 11, characterized in that the shaped parts (1, 2) are configured on rotary tools, between which the material layers (14, 15) can be transported.
